(19) United States
(12) Patent Application Publication
(10) Pub. No.: US 2010/0293283 A1
(43) Pub. Date: Nov. 18, 2010

(54) ON-DEMAND MARSHALLING AND DE-MARSHALLING OF NETWORK MESSAGES

(76) Inventors: HENRIQUE ANDRADE, Croton-on-Hudson, NY (US); Bugra Gedik, White Plains, NY (US); Kun-Lung Wu, Yorktown Heights, NY (US)

Correspondence Address: WALL & TONG, LLP;IBM CORPORATION, 25 James Way, Eatontown, NJ, 07724, US

(21) Appl. No.: 12/464,599

(22) Filed: May 12, 2009

(51) Int. Cl. G06F 15/16

(52) U.S. Cl. 709/230

(57) ABSTRACT

One embodiment of a method for on-demand de-marshalling of a network message includes receiving a first network message at a receiver device, wherein the first network message was sent from a sender device, and wherein the first network message comprises one or more attributes that characterize an object at the sender device, and further wherein the first network message is in an encoded format according to a network protocol, storing the first network message in a buffer of the receiver device in the encoded format, identifying, at the receiver device and prior to de-marshalling of any of the attributes, that at least one of the attributes is to be manipulated by the receiver device, de-marshalling, in response to the identifying, the identified attribute(s), and manipulating the identified attribute(s) at the receiver device.

### REFERENCE TO GOVERNMENT FUNDING

This invention was made with Government support under Contract No. H98230-07-C-0383, awarded by the United States Department of Defense. The Government has certain rights in this invention.

### BACKGROUND OF THE INVENTION

The present invention relates generally to the transportation of data over networks and relates more specifically to the on-demand marshalling and de-marshalling of network protocol messages.

Transporting data corresponding to a complex object (e.g., a C++/JAVA programming language class or structure, a database tuple, etc.) over a network requires the employment of a marshalling/de-marshalling mechanism that: (1) at a sender, transforms the object from the native context (e.g., a C++ or JAVA programming language context) to a network context (i.e., a format that can be sent over the network as a byte stream); and (2) at a receiver, transforms the object back to the native context, reconstructing it as, for example, a C++ or JAVA tuple object.

There are two main sources of computation costs associated with these operations: (1) data copying from a location in memory to a serialization buffer (at the sender) and from a de-serialization buffer back to a location in memory (at the receiver); and (2) data marshalling (i.e., encoding the object into a network message at the sender) and de-marshalling (i.e., decoding the network message back into the object at the receiver). Data marshalling is the process of encoding an object from a programming language-specific, in-memory representation (e.g., a C++ or JAVA object) into a message (i.e., a sequence of bytes) that follows a specific encoding protocol. Data de-marshalling is the process of decoding the message back into the programming language-specific, in-memory representation of the object.

Conventional data transport techniques carry out the de-marshalling operation upon receiving a message from the network. In other words, the object is fully recreated from the network byte stream in substantially real-time as the data arrives at the receiver. This can involve many wasteful operations, as it incurs the full cost of data copying and decoding even though access to the complete object may not be required. The impact of such waste is particularly significant in situations where relatively high data rate messages coming to one application from another over the network are processed by relatively slow processors or in situations where there is a constraint on the available number of computational cycles an application can make use of. Situations of these types are common in many distributed computing environments, such as stream processing middleware, publish/subscribe message routing middleware, and overlay network-based middleware (e.g., video streaming), among others.

### SUMMARY OF THE INVENTION

One embodiment of a method for on-demand de-marshalling of a network message includes receiving a first network message at a receiver device, wherein the first network message was sent from a sender device, and wherein the first network message comprises one or more attributes that characterize an object at the sender device, and further wherein the first network message is in an encoded format according to a network protocol, storing the first network message in a buffer of the receiver device in the encoded format, identifying, at the receiver device and prior to de-marshalling of any of the attributes, that at least one of the attributes is to be manipulated by the receiver device, de-marshalling, in response to the identifying, the identified attribute(s), and manipulating the identified attribute(s) at the receiver device.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating the operation of one embodiment of how the present invention may be implemented;

FIGS. 2A-2C are schematic diagrams illustrating the exemplary tuple layout of FIGS. 1A-1C from three different perspectives, according to an embodiment of the present invention;

FIG. 3 is a flow diagram illustrating one embodiment of a method for marshalling a network message, according to the present invention;

FIG. 4 is a schematic diagram illustrating one embodiment of an attribute offset or layout table built at compile time for fixed-size tuples;

FIG. 5 is a flow diagram illustrating one embodiment of a method for on-demand de-marshalling of a network message, according to the present invention;

FIG. 6 is a flow diagram illustrating a second embodiment of a method for marshalling a network message, according to the present invention;

FIG. 7 is a flow diagram illustrating a second embodiment of a method for on-demand de-marshalling of a network message, according to the present invention;

FIG. 8 is a schematic diagram illustrating one embodiment of an attribute offset or layout table built at run time for variable-size tuples; and

FIG. 9 is a high-level block diagram of the marshalling/de-marshalling method that is implemented using a general purpose computing device.

### DETAILED DESCRIPTION

In one embodiment, the invention is a method and apparatus for on-demand marshalling and de-marshalling network messages, where a message comprises a set of attributes that characterize an object. Values specified in the message for these attributes allow a receiving device to selectively de-marshall the bytes of the message into the object (i.e., to reconstruct the object from the message). In a programming language-specific format, the attributes are found via programming language-specific constructs. For example, in the C++ programming language, the “dot” operator enables access to attributes.

Embodiments of the invention employ a message marshalling and de-marshalling mechanism and machinery for transforming a byte stream (network message) into objects (e.g., C++/JAVA objects) on-demand when a new message is received, as well as transforming an object into a byte stream when a new message is sent. In one embodiment, the message encoding mechanism comprises an object layout (in embodiments in which a variable-sized object is transported over the network) and the attributes for the object in serialized form. In a further embodiment, the message de-marshalling mechanism comprises an interface for the object, which, upon the assignment to (i.e., left-hand side manipulation) or use of (i.e., right-hand side manipulation) an attribute, carries out the de-marshalling of the byte stream as needed. In particular, the interface gives the appearance that the byte stream has been de-marshaled and that specific attributes can be retrieved from the “de-marshaled” byte stream. Although embodiments of the invention are discussed within the exemplary context of the SPADE programming model, those skilled in the art will appreciate that the concepts of the present invention are applicable to any general distributed applications involving the transport of complex data objects across a network. The SPADE programming model is more fully described by Gedik et al. in “SPADE: The System S Declarative Stream Processing Engine,” SIGMOD Conference 2008: 1123-1134.

In some programming models (including SPADE), applications are built using operators. An operator is a small piece of code that carries out generic data transformations, filtering, annotation, classification, de-multiplexing, splitting, and other domain-specific operations. Two operators can interact through streams. Streams carry a potentially infinite sequence of tuples. A tuple is an object with a collection of named attributes, where each of the attributes is associated with a value. In the SPADE programming model, a tuple is a specialized JAVA or C++ class that provides access to the set of attributes it contains.

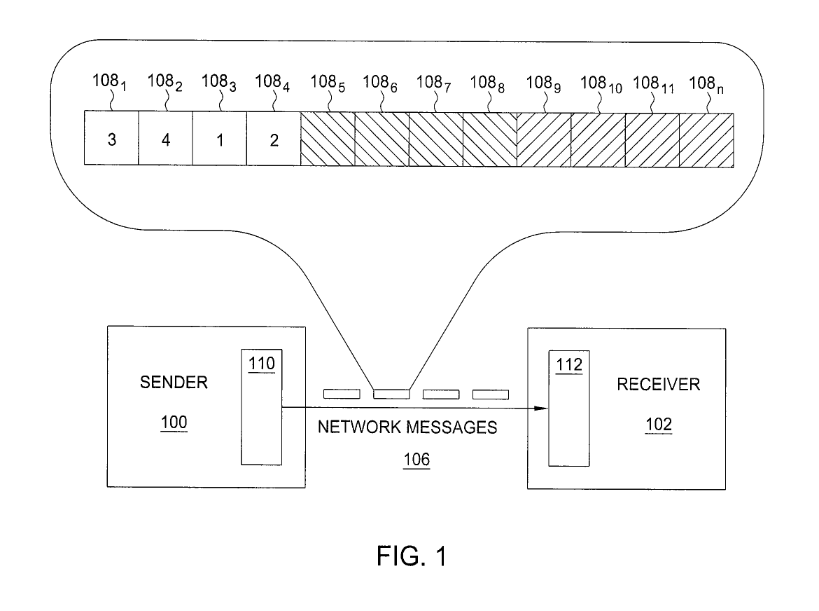

FIG. 1 is a schematic diagram illustrating the operation of one embodiment of how the present invention may be implemented. As illustrated, a first device (e.g., a sender 100) sends a data stream comprising network messages 106 to a second device (e.g., a receiver 102). One or both of the sender 100 and the receiver 102 may be configured, for example, as a general purpose computing device or as an operator in a stream processing application. As such, one or both of the sender 100 and the receiver 102 may comprise a server, a desktop computer, a laptop computer, a cellular telephone, a personal digital assistant, a gaming device or console, or any other computing device capable of sending and/or receiving data streams. For example, the sender 100 may be a server that generates data streams containing data (i.e., network messages 106) related to financial markets, infrastructure monitoring, point of sale transactions, online fraud monitoring, and/or the like.

Each item of data in the data streams represents an object stored in memory 110 (e.g., a buffer) of the sender 100. In turn, the receiver 102 stores the data streams in memory 112 (e.g., a buffer). The receiver 102 may process these data streams in order to retrieve relevant data from the raw data contained in the data streams. The retrieved data may then be subjected to further processing by the receiver 102.

As illustrated in FIG. 1 and discussed in further detail below, an on-the wire representation of a network message 106 comprises a plurality of octets 108_{I}-108ₙ (hereinafter collectively referred to as “octets 108”), where each octet contains a value for an attribute of the network message 106. Attributes of the network message 106 depend on the application. For example, if the sender 100 sends data streams related to readings produced by a temperature sensor, these attributes might include sensor temperature readings, sensor locations, and sensor reading timestamps. The values of the attributes comprise specific observations of these attributes (e.g., “thirty-two degrees Celsius,” “Yorktown Heights, N.Y.,” and “ten P.M., respectively in this example).

In the SPADE programming model, applications can be built with collections of inter-communicating operators that may span multiple distributed computing nodes communicating through stream connections in a cluster or supercomputer. When a stream connection is physically implemented on top of a network connection, the movement of tuples from a sender to a receiver is carried out by layering the stream connection on top of a network protocol. The network protocol marshalling/de-marshalling infrastructure includes serialization and de-serialization capabilities, as well as data encoding and decoding capabilities (which are necessary to address architectural differences between the node hosting the sender and the node hosting the receiver). For example, different machines may store numeric values in memory in a different order (e.g., big endian or little endian representation).

The SPADE programming model relies on code generation technologies. This means that a SPADE program specification is converted into low-level code, which includes the capability of creating classes for manipulating tuples in a programming language (e.g., C++). The compiler-generated tuple classes include manipulation methods for accessing and inspecting the values of attributes (i.e., getter methods), methods for setting the values of attributes (i.e., setter methods), as well as methods for serializing, de-serializing, encoding, and decoding the tuple contents according to a specific network protocol, implementing the marshalling and de-marshalling operations. Throughout the remainder of this description, the terms “message” and “tuple” are used somewhat interchangeably to refer to a collection of typed attributes and their corresponding values. In particular, the term “tuple” is typically used herein to refer to a C++ or JAVA representation of a multi-attribute object, whereas the term “message” is typically used herein to refer to the on-the-wire representation of a tuple (i.e., the representation of the tuple that is sent over the network).

The network protocol used by the SPADE programming model relies on a message format that comprises two components. The first component is an optional component (present only in cases of variable-sized tuples) in which the tuple layout is specified in terms of offsets for the beginning location of every attribute value. An offset defines the location of an attribute value relative to a predetermined location (e.g., the first byte) of the message. The second component stores the values for each of the attributes. In one embodiment, the values for the attributes are encoded in network byte order. The marshalling and de-marshalling methods in a SPADE-compatible tuple are respectively capable of converting the object from its native context (e.g., C++) into a byte stream message and converting the byte stream message back into the native context. The operations involved in transforming the data from a conventional in-memory representation of a tuple to an on-the-wire representation of a network message comprises marshalling the in-memory data to match the network byte order encoding, which causes computing costs to be incurred.

In general, a SPADE tuple class includes one getter method and one setter method for each tuple attribute, where the getter and setter methods comprise C++ programming language code generated by the SPADE compiler. A getter method is used to retrieve the value of an attribute in an object or message, and thus allows the inspection of the values of individual attributes of a tuple. A setter method is used to set the value of an attribute in an object or message, and thus allows attribute values to be changed. In an alternative embodiment using the C++ programming language, pseudo-attribute handles can also be employed in addition to the getter and setter methods. These handles resemble regular data members in the C++ programming language and allow one to inspect and change the values of the attributes. In the C++ programming language, these pseudo-attribute handles are implemented using operator overloading.

In one embodiment, the getter and setter methods can provide access to attributes of the network message. The setter and getter methods perform attribute-specific marshalling and de-marshalling of network messages, respectively, when called. In some embodiments, these selective operations are performed lazily on a specific object attribute as the attribute is manipulated and require the use of less computational resources than does a full object marshalling and de-marshalling from/to the wire format stored in a buffer to/from an object format stored in memory.

In one embodiment of the invention, a tuple instance object is created whenever a network message is received by a receiver. In this embodiment, the buffer holding the network message is used as a parameter of the tuple class. The tuple class constructor adjusts the specific attribute offsets that the getter and setter methods use based on the location of the attribute value in the buffer, in accordance with the first part of the network message (which contains the tuple layout) when dealing with variable-sized tuples. Such adjustments are made at compile-time for fixed-size tuples, as the tuple layout is fixed and known at that time. Full de-marshalling of the tuple is not necessarily carried out at this time.

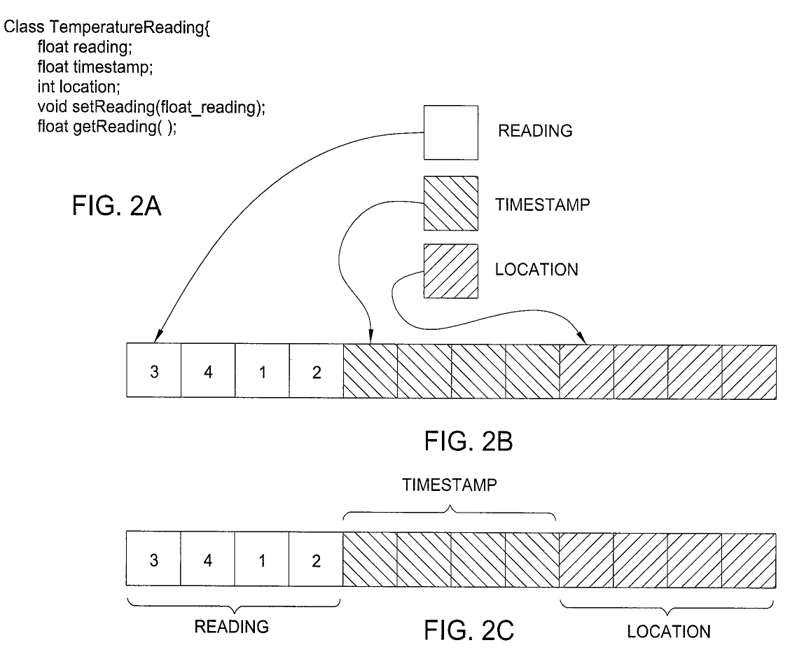

FIGS. 2A-2C are schematic diagrams illustrating an exemplary tuple layout from three different perspectives, according to an embodiment of the present invention. In particular, FIG. 2A illustrates the exemplary tuple (representing temperature readings) as a JAVA/C++ class definition; FIG. 2B illustrates the exemplary tuple as a conventional in-memory representation, where each square block of the tuple represents a memory position and holds a pointer into the de-serialization buffer; and FIG. 2C illustrates the exemplary tuple as an on-the-wire representation or byte stream, where each square block of the tuple represents an octet to be copied directly into the de-serialization buffer.

In the example illustrated, the buffer holding the network message is used as a parameter of the tuple class, and the tuple class constructor provides the necessary offset table configuration for the getter and setter methods with the location of the attribute value in the buffer, in accordance with the first part of the network message.

In accordance with the invention illustrated in FIGS. 2A-2C, as an operator (e.g., a sender or receiver) carries out its computations, the tuple is manipulated by either inspecting or changing its attributes. As discussed above, inspection is carried out using a getter method (e.g., by using the attribute member on the right-hand side of an expression), while change is carried out using a setter method (e.g., by using the attribute member on the left-hand side of an assignment).

When a getter method is invoked, or the pseudo-attribute handle is used, the de-marshalling of the attribute is carried out. In one embodiment, the de-marshalling requires decoding the relevant part of the buffer that contains the network message. In a further embodiment, the de-marshalling additionally requires a data copy operation to a new memory location. When a setter method is invoked, or the equivalent pseudo-attribute handle is used, the marshalling of the attribute is carried out.

Embodiments of the invention can be specialized depending on whether a tuple is of fixed size (i.e., the tuple schema comprises only attributes whose type is of fixed size, such as numeric types, fixed-size strings, fixed-size vectors, or the like) or is of variable size (i.e., the tuple schema comprises two or more attributes whose type is of variable size, such as a regular string, an unbounded list of floating points numbers, or the like). When a tuple comprises only one attribute of a variable size, the approach set forth for a fixed-size tuple can still be implemented, as described in greater detail below.

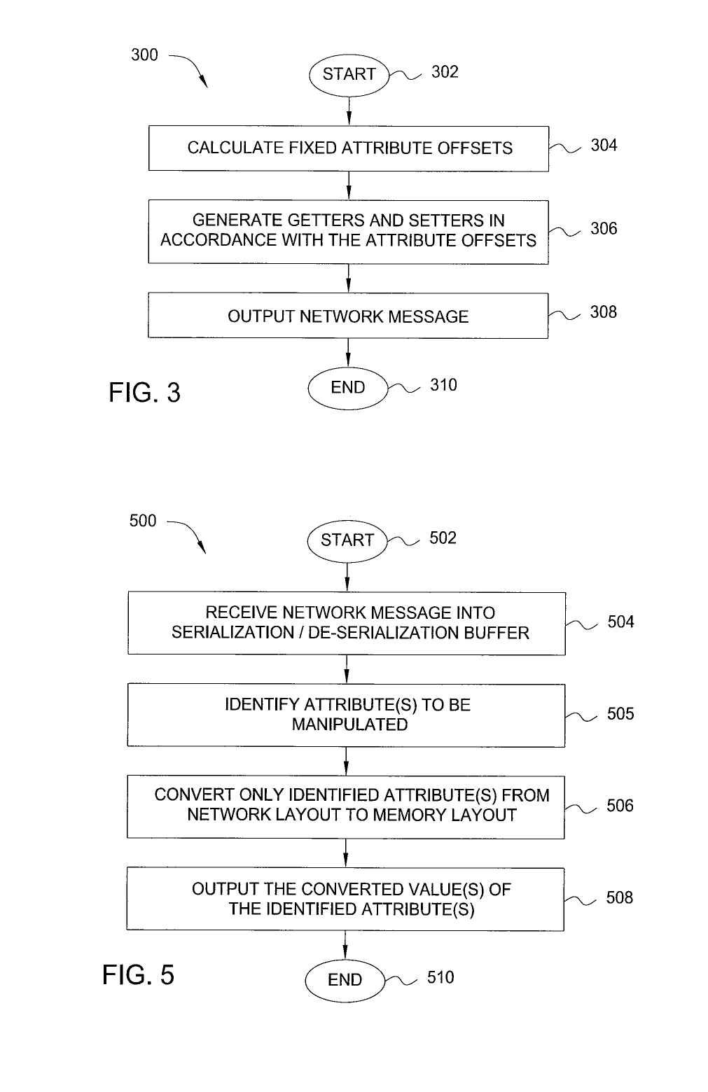

FIG. 3 is a flow diagram illustrating one embodiment of a method 300 for marshalling a network message, according to the present invention. Specifically, the method 300 is used to encode a network message comprising a fixed-size tuple layout, in which all attributes of the tuples have sizes that are known at application compile time. As such, the method 300 may be implemented, for example, at a sender or producer operator.

When the tuple size is fixed, only fixed-size types are employed to represent the tuple's attributes. In this case, an on-the-wire protocol message such as that employed by the SPADE programming model can be streamlined to include only the data encoding that corresponds to a tuple. In other words, the tuple layout portion of the network message can be eliminated, because the offsets for different attributes can be inferred from the sizes of the types of the tuple attributes at compile time. This optimization can also be applied to variable-size tuples that comprise only one variable-size attribute. In this case, the optimization can be applied because the one attribute of variable size can be placed last inside the network message, which allows the initial offset for the variable-size attribute to be computed in the same manner as the initial offsets for the other (fixed-size) attributes.

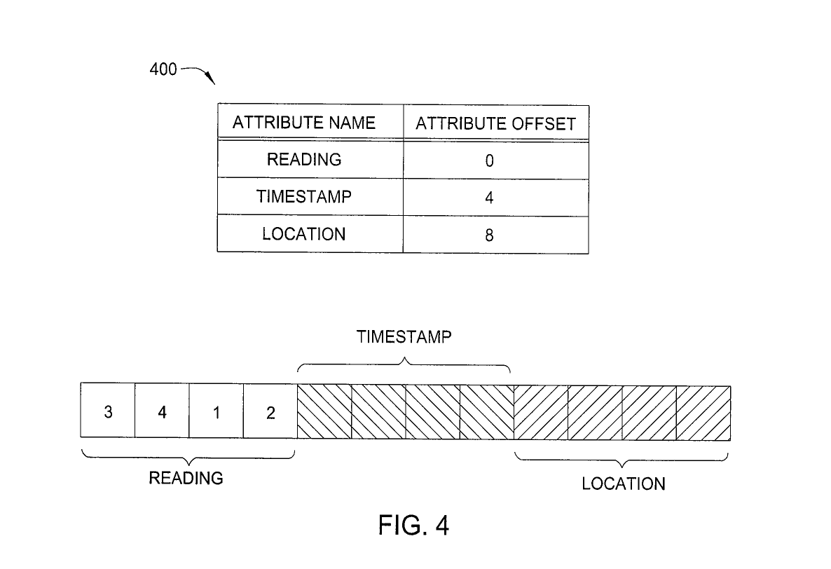

The method 300 is initialized at step 302 and proceeds to step 304, where the compiler calculates the fixed attribute offsets. FIG. 4 is a schematic diagram illustrating one embodiment of an attribute offset or layout table 400 built at compile time for fixed-size tuples.

In step 306, the compiler generates code for implementing getter and setter methods, as well as pseudo-attribute handles (e.g., in C++ programming language implementation), as part of a tuple class that implements the tuple schema being used by an application. The code is generated in accordance with the pre-determined attribute offsets calculated in step 304. The code is generated such that the getter and setter methods access the serialization/de-serialization buffer at a receiver rather than a memory position, as discussed in greater detail below.

In step 308, the compiler 300 outputs the network message (including the code for the getter and setter methods, which have been encoded therein), for example to a receiver or consumer operator. The method 300 then terminates in step 310.

FIG. 5 is a flow diagram illustrating one embodiment of a method 500 for on-demand de-marshalling of a network message, according to the present invention. Specifically, the method 500 is used to decode a network message as the network message is being received (i.e., at runtime). More specifically, the method 500 is used to decode a network message comprising a fixed-size tuple layout, in which all attributes of the tuples have sizes that are known at application compile time (e.g., such as a network message generated in accordance with the method 300, discussed above).

The method 500 is initialized in step 502 and proceeds to step 504, where a network message is received into a serialization/de-serialization buffer. In step 505, the method 500 identifies one or more attributes of the network message that are to be manipulated (de-marshaled). The attribute(s) may be identified, for example, in accordance with a user request that makes use of the getter method stored in the receiving device.

In step 506, only the identified attribute(s) (e.g., “reading,” “timestamp,” “location,” or another attribute) of the network message are converted from a network layout to a memory layout (e.g., as illustrated in FIG. 2B). The method 500 then outputs the converted value(s) (i.e., the value(s) as specified in the memory layout) of the identified attribute(s) in step 508 before terminating in step 510.

Thus, the methods 300 and 500 exploit a priori knowledge of message layout by pre-configuring the getter and setter methods with the offsets necessary to retrieve attributes from the serialization/de-serialization buffer.

In one embodiment, when an attribute of a tuple is manipulated, additional data encoding data copying operations pertaining to the marshalling operation are carried out by the methods 300 and 500, respectively. Specifically, at runtime, once the tuple is received into the serialization/de-serialization buffer, additional operations (such as byte swapping and other protocol-required encoding transformations) are carried out, only if needed, on the serialization/de-serialization buffer on the specific offset pointed to by the getter and setter methods.

Similar methods may be used to encode and decode network messages comprising variable-size tuple layouts. In such instances, two additional sources of overhead must be accounted for. First, additional network traffic is incurred as per-tuple layout tuples must be sent with the actual data stored in the tuple. Second, additional computational costs are incurred as the layout table must be computed for each new tuple.

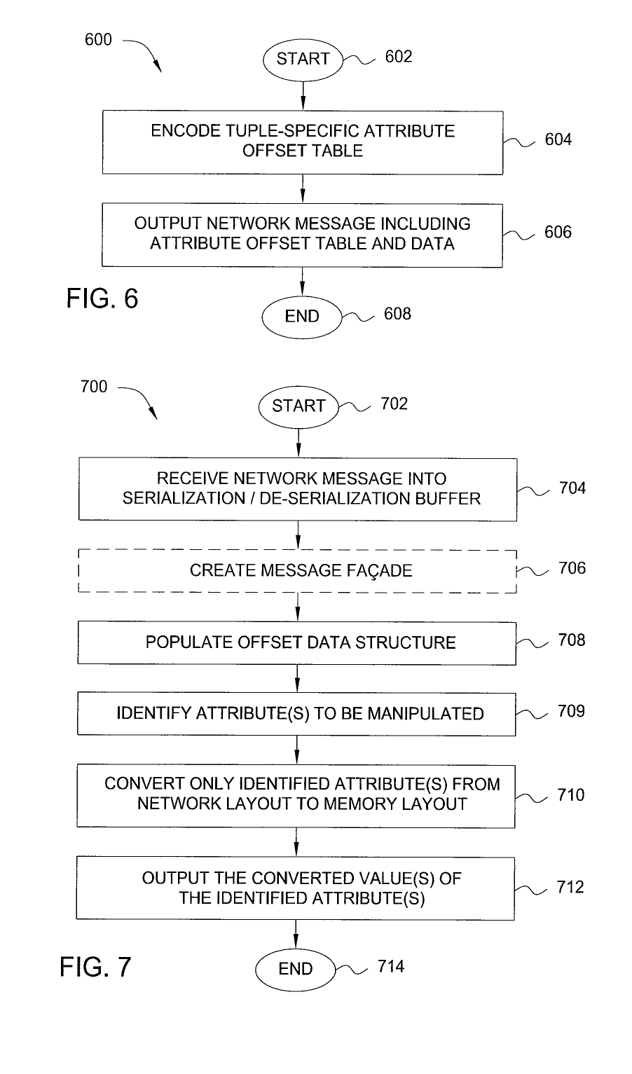

FIG. 6 is a flow diagram illustrating a second embodiment of a method 600 for marshalling a network message, according to the present invention. Specifically, the method 600 is used to encode a network message comprising a variable-size tuple layout, in which two or more attributes of the tuples have sizes that are not known at application compile time. As such, the method 600 may be implemented, for example, at a sender operator and carried out at runtime.

The method 600 is initialized at step 602 and proceeds to step 604, where the compiler encodes a tuple-specific layout table, such as the layout table 400 illustrated in FIG. 4. This step is also carried out by the tuple class by invoking a layout computation class technique. The serialization method implemented by the tuple class encodes both the layout table and the actual data contained in the tuple.

In step 606, the compiler 600 outputs the network message (which includes the layout table and the data), for example to a receiver or consumer operator. The method 600 then terminates in step 608.

FIG. 7 is a flow diagram illustrating a second embodiment of a method 700 for on-demand de-marshalling of a network message, according to the present invention. Specifically, the method 700 is used to decode a network message as the network message is being received (i.e., at runtime). More specifically, the method 700 is used to decode a network message comprising a variable-size tuple layout, in which two or more attributes of the tuples have sizes that are not known at application compile time (e.g., such as a network message generated in accordance with the method 600, discussed above).

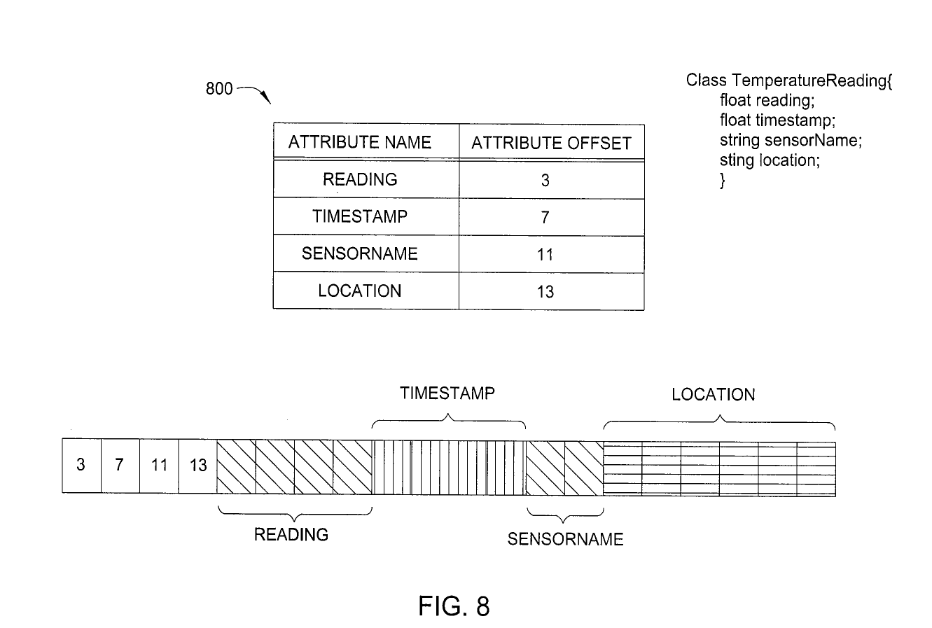

The method 700 is initialized at step 702 and proceeds to step 704, where the method 700 receives a network message into a serialization/de-serialization buffer. The method 700 then proceeds to optional step 706 (illustrated in phantom) and creates an interface mechanism (i.e., the set of pseudo-attribute handles, one set per tuple attribute) by which direct access to message data members uses regular member access through the dot operator available in the C++ programming language for this purpose. This interface mechanism is implemented, for example, when programming languages that support operator overload (e.g., the C++ programming language) are implemented. An offset data structure (e.g., layout table) is then populated in step 708. FIG. 8 is a schematic diagram illustrating one embodiment of an attribute offset or layout table 800 built at run time for variable-size tuples. A layout table such as the layout table 800 is built for every network message that arrives at the receiver.

In step 709, the method 700 identifies one or more attributes of the network message that are to be manipulated (de-marshaled). The attribute(s) may be identified, for example, in accordance with a user request that makes use of the getter method stored in the receiving device. In step 710, the method 700 reads the layout table and the tuple data from the wire into the serialization/de-serialization buffer. That is, the identified attribute(s) (e.g., “reading,” “timestamp,” “location,” or another attribute) of the network message are converted from a network layout to a memory layout (e.g., as illustrated in FIG. 2B).

The method 700 then outputs the converted value(s) (i.e., the value(s) as specified in the memory layout) of the identified attribute(s) in step 712 before terminating in step 714.

Thus, the methods 600 and 700 use the first part of the network message (which contains the message layout) in order to adjust the getter and setter methods with the location of the attribute value in the serialization/de-serialization buffer.

The getter and setter methods must be adjusted because when variable-sized tuples are received, one does not know where the boundaries of the data lie. Consider this contrived example with the following C++ programming language class:

```
class Employee {
  string name; //a variable size attribute
  int age; //a fixed size attribute
};
```

Using this exemplary class definition, a person named Henrique who is thirty-six years old would send the message “HENRIQUE36,” in which the “age” value begins in the ninth octet of the message. However, a person named Joe who is forty-five years old would send the message “JOE45,” in which the “age” value begins in the fourth octet of the message. Thus, when one is “getting” the age using the getter method, the getter method must be adjusted with knowledge of the actual offset given in the message. As discussed above, embodiments of the invention accomplish this adjustment by sending the layout of the message before the message. Referring again to the above example, the layout for the message “HENRIQUE45” would carry the following information:
Name attribute starts at the 0^{th} octet
Age attribute starts at the 9^{th} octet
   whereas the layout for the message “JOE45” would carry this information:
Name attribute starts at the 0^{th} octet
Age attribute starts at the 4^{th} octet

Thus, in one embodiment, the method 700 invokes the getter and setter methods, which employ the layout table to assess the specific location of an attribute in the serialization/de-serialization buffer and to optionally perform data decoding and data copying operations only as specific attributes of the tuple are manipulated. On set or write operations, where two or more of the tuple attributes are of variable size, it may not be possible to perform in-place operations in the specific location of the attribute in the serialization/de-serialization buffer. For example, if the size of the attribute being manipulated changes, writing the attribute value back requires rewriting the serialization buffer, because space may have to be removed or added to accommodate the new size of the changed attribute. In one embodiment, the present invention invalidates the serialization buffer in such situations and, when the tuple is re-sent, a new serialization buffer is lazily generated.

The present invention thus implements data stream marshalling and de-marshalling in a more efficient manner than conventional methods. For example, a data stream might be subject to filtering irrelevant tuples (i.e., tuples that do not match a filtering predicate expression) by an operator. Filtering is typically performed on only a subset of the attributes carried by a tuple (e.g., all tuples whose tag is equal to “video frames from news source A”). According to embodiments of the present invention, only those portions of the tuple that are relevant to the filtering criteria would undergo de-marshalling, thereby minimizing waste of computational resources. Irrelevant portions of the tuple are left untouched or unprocessed. Moreover, by conserving the serialized version of a network message, re-serialization can be avoided when the same tuple is forwarded (e.g., when the video frame carried by the tuples is from news source A and meets the filtering criteria, to follow the example above). Thus, the additional costs of a data copy and marshalling can be avoided.

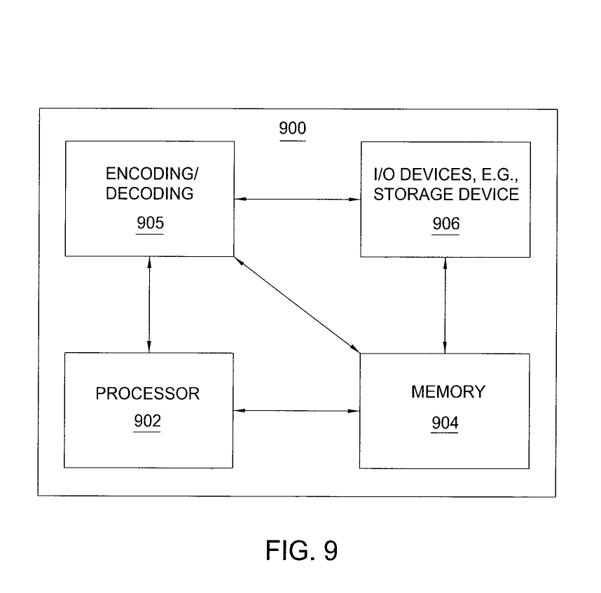

FIG. 9 is a high-level block diagram of the marshalling/de-marshalling method that is implemented using a general purpose computing device 900. In one embodiment, a general purpose computing device 900 comprises a processor 902, a memory 904, a marshalling/de-marshalling module 905 and various input/output (I/O) devices 906 such as a display, a keyboard, a mouse, a stylus, a wireless network access card, and the like. In one embodiment, at least one I/O device is a storage device (e.g., a disk drive, an optical disk drive, a floppy disk drive). It should be understood that the marshalling/de-marshalling module 905 can be implemented as a physical device or subsystem that is coupled to a processor through a communication channel.

Alternatively, the marshalling/de-marshalling module 905 can be represented by one or more software applications (or even a combination of software and hardware, e.g., using Application Specific Integrated Circuits (ASIC)), where the software is loaded from a storage medium (e.g., I/O devices 906) and operated by the processor 902 in the memory 904 of the general purpose computing device 900. Thus, in one embodiment, the marshalling/de-marshalling 905 for marshalling and de-marshalling network protocol messages, as described herein with reference to the preceding figures can be stored on a computer readable storage medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying figures that recite a determining operation or involve a decision, do not necessarily require that both branches of the determining operation be practiced. In other words, one of the branches of the determining operation can be deemed as an optional step.

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

What is claimed is:

1. A method for de-marshalling a network message, the method comprising:
receiving a first network message at a receiver device, wherein the first network message was sent from a sender device, and wherein the first network message comprises one or more attributes that characterize an object at the sender device, and further wherein the first network message is in an encoded format according to a network protocol;
storing the first network message in a buffer of the receiver device in the encoded format;
identifying, at the receiver device and prior to de-marshalling of at least one of the one or more attributes, that the at least one of the one or more attributes is to be manipulated by the receiver device;
de-marshalling, in response to the identifying, the at least one of the one or more attributes; and
manipulating the at least one of the one or more attributes at the receiver device.

2. The method of claim 1, wherein the method interacts with an interface at the receiver device, and wherein the interface gives a user of the receiver device an appearance that the first network message is de-marshaled.

3. The method of claim 1, wherein the de-marshalling comprises:
obtaining, by the receiver device, an offset for the at least one of the one or more attributes, where the offset identifies a location in the buffer of a value of the at least one of the one or more attributes relative to a predetermined position in the first network message.

4. The method of claim 3, wherein the at least one of the one or more attributes is of a fixed size.

5. The method of claim 4, wherein the offset is stored at the receiver device in an attribute getter method that is used to retrieve values of the one or more attributes.

6. The method of claim 5, wherein the offset is pre-computed by a compiler.

7. The method of claim 5, wherein the offset is obtained from an object layout structure stored in the attribute getter method.

8. The method of claim 5, wherein the obtaining is further performed using a pseudo-attribute handle.

9. The method of claim 3, wherein the at least one of the one or more attributes is of a variable size.

10. The method of claim 9, wherein the offset is obtained from an object layout structure.

11. The method of claim 10, wherein the object layout structure is received, by the receiver device, in a second network message, and wherein the second network message was sent by the sender device prior to sending of the first network message.

12. The method of claim 11, wherein the object layout structure is populated by the receiver device in accordance with processing logic stored in an attribute getter method, and wherein the attribute getter method is adjusted in accordance with the second message.

13. The method of claim 12, wherein the obtaining is further performed using a pseudo-attribute handle.

14. The method of claim 11, wherein the first network message is marshaled by the sender device by:
storing the first network message in a buffer of the sender device; and
storing, by the sender device, the offset in an attribute setter method that is used to set values of the one or more attributes.

15. The method of claim 14, wherein storing the offset further comprises:
setting the values using a pseudo-attribute handler.

16. The method of claim 1, wherein the de-marshalling is performed in real time as the first network message is received by the receiver device.

17. An apparatus comprising a computer readable storage medium containing an executable program for de-marshalling a network message, where the program performs the steps of:
receiving a first network message at a receiver device, wherein the first network message was sent from a sender device, and wherein the first network message comprises one or more attributes that characterize an object at the sender device, and further wherein the first network message is in an encoded format according to a network protocol;
storing the first network message in a buffer of the receiver device in the encoded format;
identifying, at the receiver device and prior to de-marshalling of at least one of the one or more attributes, that the at least one of the one or more attributes is to be manipulated by the receiver device;
de-marshalling, in response to the identifying, the at least one of the one or more attributes; and
manipulating the at least one of the one or more attributes at the receiver device.

18. The apparatus of claim 17, wherein the program interacts with an interface at the receiver device, and wherein the interface gives a user of the receiver device an appearance that the first network message is de-marshaled.

19. The apparatus of claim 17, wherein the de-marshalling comprises:
obtaining, by the receiver device, an offset for the at least one of the one or more attributes, where the offset identifies a location in the buffer of a value of the at least one of the one or more attributes relative to a predetermined position in the first network message.

20. The apparatus of claim 19, wherein the offset is stored at the receiver device in an attribute getter method that is used to retrieve values of the one or more attributes.

21. The apparatus of claim 20, wherein the offset is obtained from an object layout structure stored in the attribute getter method.

22. The apparatus of claim 20, wherein the offset is obtained from an object layout structure.

23. The apparatus of claim 22, wherein the object layout structure is received, by the receiver device, in a second network message, and wherein the second network message was sent by the sender device prior to sending of the first network message.

24. An apparatus for marshalling and de-marshalling a network message, comprising:
a buffer for storing the network message, where the network message comprises one or more attributes that characterize an object stored in memory, and further wherein the network message is in an encoded format according to a network protocol;
a processor for generating one or more offsets, each of the one or more offsets identifying a location in the buffer of a value of one of the one or more attributes relative to a predetermined location in the network message; and
a compiler for generating executable code for at least one of an attribute getter method and an attribute setter method, where the attribute setter method is used to set values of the one or more attributes and the attribute getter method is used to retrieve the values of the one or more attributes.

25. The apparatus of claim 24, further comprising:
an interface that interacts with the processor, wherein the interface gives a user of the apparatus an appearance that the network message is marshaled or de-marshaled.
